(19) United States
(12) Patent Application Publication
(10) Pub. No.: US 2026/0086035 A1
(43) Pub. Date: Mar. 26, 2026

(54) MICROSCOPE-BASED SYSTEM AND METHOD OF DETERMINING BEAM PROCESSING PATH

(71) Applicant: SYNCELL (TAIWAN) INC., Taipei City (TW)

(72) Inventors: Jung-Chi LIAO, Taipei City (TW); Yong Da SIE, Taipei City (TW)

(21) Appl. No.: 19/110,325

(22) PCT Filed: Sep. 6, 2023
(86) PCT No.: PCT/US2023/073512

§ 371 Date: Mar. 10, 2025

Related U.S. Application Data
(60) Provisional application No. 63/374,931, filed on Sep. 8, 2022.

(51) Int. Cl. G01N 21/64

(52) U.S. Cl. CPC G01N 21/6458; G01N 21/6428; G01N 2021/6439; G01N 2201/0668; G01N 2201/0691

(57) ABSTRACT

A microscope-based system is provided. The microscope-based system includes an illumination assembly comprising an illumination light source and a pattern illumination device, and a processing module coupled to the illumination light source and the pattern illumination device. The processing module is configured to identify regions of interest in a sample to generate a two-dimensional illumination mask for each of the multiple fields of view, and for each field of view, determine an illumination sequence of the regions of interest by minimizing a sum of a plurality of region-to-region traveling distances between sequential regions of interest, determine an illumination path following the illumination sequence within each of the regions of interest, and control the illumination light source and the pattern illumination device to illuminate the regions of interest based on the illumination sequence and the illumination path for each of the multiple fields of view. Methods of use are also provided.

### CLAIM OF PRIORITY

This application claims priority to U.S. Provisional Patent Application No. 63/374,931, filed on Sep. 8, 2022, titled “MICROSCOPE-BASED SYSTEM AND METHOD OF DETERMINING BEAM PROCESSING PATH,” which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

High-sensitivity hypothesis-free subcellular proteomics is challenging due to the limited sensitivity of mass spectrometry and the lack of amplification tools for proteins. Without such technology, it is not possible to discover proteins at specific locations of interest in bulk for cell and tissue samples.

Spatial proteomics allows protein mapping of a biological sample to reveal a geometrical framework for underlying protein-protein interactions. Cell biologists and histologists are largely benefited by recent development of spatial proteomics, enabling, e.g., disease-associated microenvironmental protein mapping, architectural protein distribution on a structured histological sample, or protein identification of specific organelles. Targeted spatial proteomics aims to localize known proteins, whereas de novo spatial proteomics requires spatial protein identification without prior knowledge of what proteins to look for. Unlike transcriptomics where PCR is used to amplify the signals so that de novo transcriptomics like RNAseq is possible, no PCR-equivalent technology is yet available for proteomics.

Two major techniques are feasible for de novo spatial proteomics: microscopy and mass spectrometry (MS). Strictly speaking, microscopy is a targeted approach relying on fluorescent protein or fluorescent dye labeling. The recent large-scale immunostaining of the Protein Atlas Project mapped thousands of protein species, making it equivalently a de novo spatial proteomic database. The limit of this approach is its application to specific biological problems, where a new multi-year exhaustive process would have to be implemented again as for a biological sample with a specific mutation.

MS has long been implemented to identify de novo proteomes. Immunoprecipitation (IP) and MS together is a widely used biochemical approach to identify a proteome associated with a bait protein. Recent proximity labeling (PL) approaches provide better spatial precision close to the bait protein. Results from IP and PL sometimes suffer low specificity, potentially due to non-specific interactions through the pulldown processes.

Laser-capture microdissection (LCM) enables protein isolation at specific regions of interest and subsequent de novo spatial proteome identification. However, the beam size of the cutting laser is too large to achieve spatial precision. Its non-discriminative axial cutting introduces non-specific noise and reduces specificity.

Recent development of spatially targeted optical microproteomics (STOMP) and its derivative approaches offer another de novo spatial proteomics tool to identify the proteome at specific regions of interest under a microscope. However, it lacks the fundamental scaleup requirement to reach MS need for sensitivity and specificity, challenging to identify low abundant proteins.

### SUMMARY OF THE DISCLOSURE

In view of the foregoing objectives, U.S. Pat. No. 11,265,449 disclosed an image-guided systems and method to enable illuminating varying patterns on sample. With a unique integration of optical, photochemical, image processing, and mechatronic design, such systems and methods have abilities to process a high content of proteins, lipids, nucleic acids, or biochemical species for regulation, conversion, isolation, or identification in an area of interest based on user-defined microscopic image features, widely useful for cell or tissue sample experiments. More specifically, the present technology labels (using, for example, biotinylate) proteins at the regions of interest (ROIs) of a biological sample, and then applies proximity photolabeling to tag the proteins accurately in the target area. After photolabeling, the biotinylated proteins are extracted from the samples and subjected to mass spectrometry proteome analysis. Photo-induced labeling assures low background so that microscopy-guided proteomics become feasible. However, one usually needs at least one day to illuminate ten of thousands of FOVs. Recognized herein is a need for the improved methods for photolabeling proteins one FOV within a reasonable duration of time.

In an aspect, the present invention provides a microscope-based system for rapid illumination of a plurality of regions of interest among multiple fields of view of a biological sample, comprising a light source, a pattern illumination device, and a processing module coupled to the light source and the pattern illumination device, wherein the processing module is configured to identify regions of interest for each of the multiple fields of view; for each field of view, determine an illumination sequence of the regions of interest by minimizing a sum of a plurality of region-to-region traveling distances between sequential regions of interest; and control the light source and the pattern illumination device to illuminate the regions of interest based on the illumination sequence, wherein the illumination sequences differ among the multiple fields of view.

In another aspect, the present invention also provide a computer implemented for rapid illumination of a plurality of regions of interest among multiple fields of view of a biological sample executing in a processor of a computer, comprising: identifying regions of interest for each of the multiple fields of view; for each field of view, determining an illumination sequence of the regions of interest by minimizing a sum of a plurality of region-to-region traveling distances between sequential regions of interest; for each field of view, determining an illumination path following the illumination sequence within each of the regions of interest; and controlling the light source and the pattern illumination device to illuminate the regions of interest based on the illumination sequence and the illumination path, wherein the illumination sequences differ among the multiple view fields.

In some embodiments, the region-to-region traveling distances is the sum of straight-line distance between the center point of each of the region of interest.

In some embodiments, the processing module is further configured to determine an illumination path within each of the regions of interest following the illumination sequence.

In some embodiments, the processing module is further configured to control the light source and the pattern illumination device to illuminate the regions of interest according to the illumination path and to prevent illumination outside of the regions of interest.

In some embodiments, the illumination path extends from a start point located at a boundary of a first region of interest of the sequence.

In some embodiments, each of the regions of interest is not overlapped or connected with any other region of interest in one of the fields of view.

In some embodiments, the illumination path comprises a plurality of illumination stop points and illumination resuming points, and each of the illumination stop points indicates an individual coordinate for switching to each of the resuming points.

In some embodiments, one of the resuming points is located within one of the regions of interest and surrounded by a boundary thereof.

In some embodiments, one of the resuming points is located at a boundary of one of the regions of interest.

In some embodiments, the processing module determines the illumination path by minimizing the number of the stop points and the number of the resuming points so as to minimize a total distance of the illumination path.

In some embodiments, the illumination path comprises a termination point for a first field of view of the multiple fields of view, the processing module being further configured to cease illumination of the illumination path for the first field of view at the termination point.

In some embodiments, the processing module is further configured to control the light source and the pattern illumination device to illuminate the regions of interest from the start point or each resuming point to each stop point, prevent illumination of the regions of interest from each stop point to each resuming point, and cease illumination of the regions of interest at the termination point.

A method is provided, comprising: identifying at least one region of interest among multiple fields of view of a biological sample; generating a two-dimensional illumination mask for each of the multiple fields of view; for each of the multiple fields of view, determining an illumination sequence of the at least one region of interest by minimizing a sum of a plurality of region-to-region traveling distances between sequential regions of interest; for each field of view, determining an illumination path following the illumination sequence within each of the regions of interest; and controlling an illumination light source and a pattern illumination device of a microscope-based system to illuminate the regions of interest based on the illumination sequence and the illumination path for each of the multiple fields of view.

In one aspect, the region-to-region traveling distances is the sum of straight-line distance between the center point of each of the region of interest.

In another aspect, the method includes controlling the illumination light source and the pattern illumination device to illuminate the regions of interest according to the illumination path and to prevent illumination outside of the regions of interest.

In some aspects, the illumination path extends from a start point located at a boundary of a first region of interest of the sequence.

In one aspect, each of the regions of interest is not overlapped or connected with any other region of interest in one of the fields of view.

In some aspects, the illumination path includes a plurality of stop points and resuming points, and each of the stop points indicates an individual coordinate for switching to each of the resuming points.

In one aspect, one of the resuming points is located within one of regions of interest and surrounded by a boundary thereof.

In another aspect, one of the resuming points is located at a boundary of one of the regions of interest.

In some aspects, the step of determining the illumination path comprises minimizing a number of the stop points and resuming points so as to minimize a total distance between every two regions of interest in the illumination path.

In one aspect, the illumination path comprises a termination point for a first field of view of the multiple fields of view, and the method further comprises ceasing illumination of the illumination path for the first field of view at the termination point.

In some aspects, the method further comprises controlling the illumination light source and the pattern illumination device to start illumination of the regions of interest at the start point or each resuming point, to temporally stop illumination of the regions of interest from each stop point to each resuming point, and to cease illumination of the regions of interest at the termination point for each of the multiple fields of view.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 represents a schematic diagram of a microscope-based system according to one embodiment of the present invention.

FIG. 2 is a flow chart of the computer implemented method of determining rapid illumination on a plurality of regions of interest among multiple view fields of a biological sample executing by the processing module.

FIG. 3A represents an image of one field of view of sample S acquired by the image assembly.

FIG. 3B represents an exemplary illumination mask of the image of FIG. 3A.

FIG. 3C represents an exemplary illumination sequence determined by the processing module according to the present invention.

FIGS. 3D, 3E, and 3F depict the illumination path of the corresponding region of interest.

FIG. 4 depicts the illumination path of two regions of interest according to another embodiment of the present invention.

FIG. 5 depicts a schematic diagram of a microscope-based system according to another embodiment of the present invention.

### DETAILED DESCRIPTION

The embodiments of the invention will be apparent from the following detailed description, which proceeds with reference to the accompanying drawings, wherein the same references relate to the same elements.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

As used herein, the term “beam” is a laser beam used as illumination light source of the present invention. In one embodiment, a femtosecond laser may be used as the illumination light source to generate a two-photo effect for high axial illumination precision.

As used herein, the term “region of interest” is defined by the user. They can be the locations of cell nuclei, nucleoli, mitochondria, or any cell organelles or subcellular compartments. They can be the locations of a protein of interest, or a morphological signature. They can also be a feature defined by two color imaging, such as the colocation sites of protein A and B, or actin filaments close to the centrosome.

As used herein, the term “illuminate” refers to shine the photosensitizing light on the points or areas to achieve localized photolabeling, wherein the molecule can be proteins, amino acids, lipids, or nucleic acids. The photolabeling progress is achieved by including photosensitizer such as riboflavin, Rose Bengal or photosensitized protein (such as miniSOG and Killer Red, etc.) and chemical reagents such as phenol, aryl azide, benzo-phenone, Ru(bpy)32+, or their derivatives for labeling purpose.

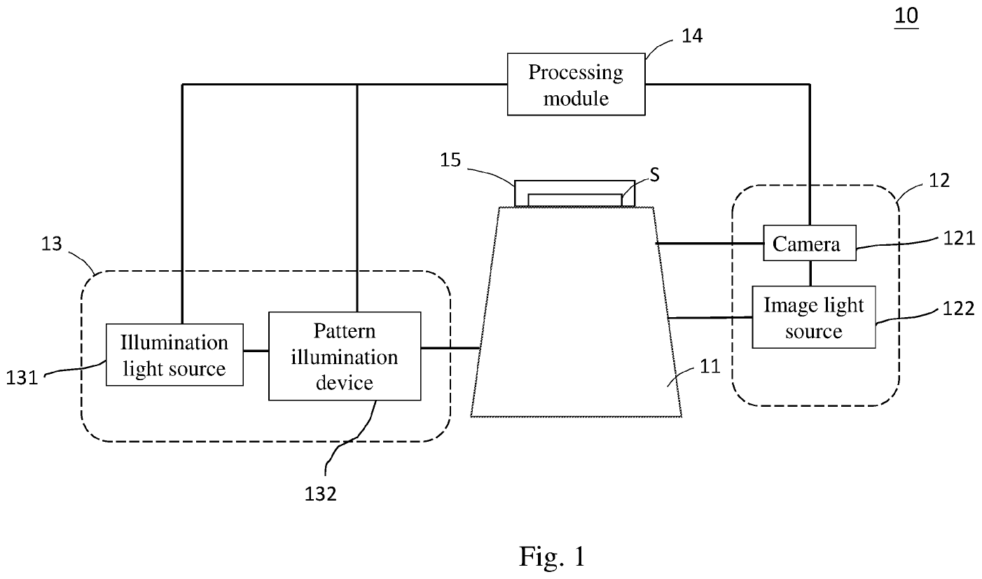

Examples of the microscope-based system and illumination method of the present invention include those described in U.S. Pat. No. 11,265,449, which is entirely incorporated herein by reference for all purposes. In one embodiment as depicted in FIG. 1, the microscope-based system 10 of the present invention may comprise, for example, but not limited thereto, a microscope 11, an imaging assembly 12, an illuminating assembly 13, and a processing module 14. The microscope 11 comprises an objective (not shown in FIG. 1) and a high-precision microscope stage 15, wherein the stage 15 is configured to be loaded with a sample S. The imaging assembly 12 may comprise a camera 121 and an imaging light source 122. The illuminating assembly 13 may comprise an illumination light source 131 and a pattern illumination device 132.

In this embodiment, the illumination light source 131 is different from imaging light source 122 used for sample imaging, such as a LED light. The illumination light source 131 here is used only to illuminate the interested regions determined by image processing and is achieved by point scanning. That is, the illumination light source 131 may be a laser, and the point scanning is achieved by scanning mirrors such galvanometer mirrors. For example, one can use femtosecond laser as the illumination light source 131.

In this embodiment, the processing module 14 is coupled to the microscope 11, the imaging assembly 12, and the illuminating assembly 13. In another embodiment, the microscope-based system 10 may comprise a first processing module independently control the imaging assembly 12, and a second processing module independently control the illumination device 13. The processing module 14 can be a computer, a workstation, or a CPU of a computer, which is capable of executing a program designed for operating this system.

In some embodiments, the processing module 14 employs four sequential steps, repeated tens of thousands of times. Step 1: the processing module 14 controls the imaging assembly 12 such that the camera 121 acquires at least one image of the sample S of a first field of view (FOV): Step 2: the image or images are transmitted to the processing module 14 automatically in real-time based on a predefined criterion so as to identify region of interest (ROI) by image processing and to generate an illumination mask of the image of the biological sample S and; Step 3: the processing module 14 controls the illuminating assembly 13 to illuminate the ROIs of the sample S according to the illumination mask; and Step 4: after the ROIs are fully illuminated, the processing module 14 controls the stage 15 to move to a second field of view which is subsequent to the first FOV.

This repetitive process, performed rapidly, provides enough of the target protein (found, e.g., in target cellular structures) to overcome the fundamental problem of the lack of a viable protein amplification technology. Prior art technology is not optimized to perform such a process with so many repetitions within a few hours. Without such speed, one would only be able to identify high-abundant proteins, which are mostly already known.

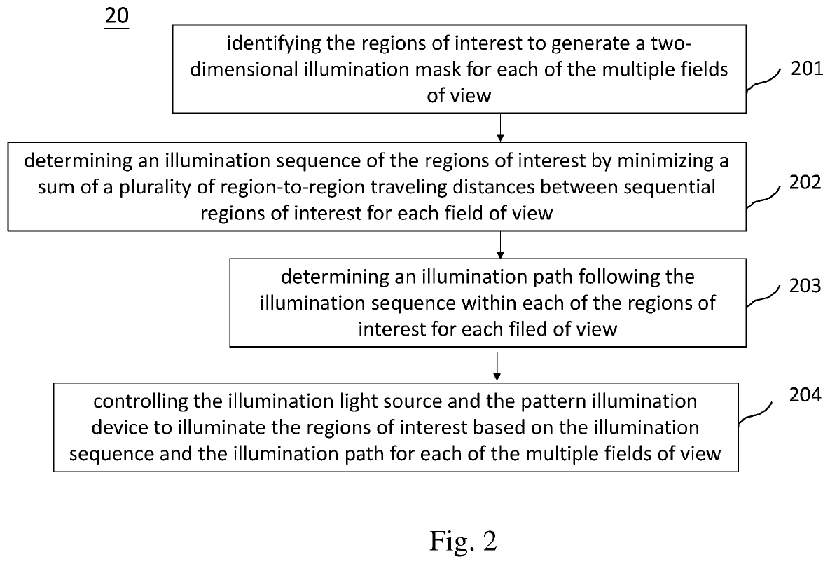

To improve the illumination performance, the present invention provides a microscope-base system for rapid illumination of a plurality of regions of interest among multiple field of view of a biological sample, comprising a processing module configured to employ an algorithm to plot an efficient illumination sequence and the shortest illumination path within and between the regions of interest in each field of view. Please refer to FIG. 2. The processor module of the present invention is configured to execute a computer implemented method including steps 201, 202, 203 and 204.

In the step 201, the processing module is configured to identify the regions of interest to generate a two-dimensional illumination mask for each of the multiple fields of view. As described above, a biological sample S is loaded on the stage, and the processing module controls the image assembly to acquire images of the biological sample S for each of the multiple fields of view. The images can be fluorescent staining images or bright-field images. Image processing is then performed automatically on the images by the processing module or a connected computer using image processing techniques such as thresholding, erosion, filtering, or trained artificial intelligence method to identify the regions of interest based on the criteria set by the user. After image processing, a two-dimensional illumination mask merely showing all desired regions of interest for each of the multiple fields of view for illumination afterward is generated by the processing module. According to the present invention, each identified region of interest exists individually. In other words, each of the regions of interest is not overlapped or connected with any other region of interest in one of the fields of view. If two or more regions of interest is overlapped or connected with each other, these regions of interest are considered as “one” region of interest.

In the step 202, the processing module is configured to determine an illumination sequence of the regions of interest by minimizing a sum of a plurality of region-to-region traveling distances between sequential regions of interest for each field of view. The illumination sequence herein refers to sort the regions of interest in a sequence based on a distribution of the regions of interest, wherein a total distance between every two regions of interest in the sequence is at a minimum. In other words, if we can shorten the time for illumination of the regions of interest, sum of a plurality of region-to-region traveling distances between sequential regions of interest is at a minimum. In one embodiment of the present invention, the region-to-region traveling distances is the sum of straight-line distance between the center point of each of the region of interest.

In step 203, the processing module is configured to determine an illumination path following the illumination sequence within each of the regions of interest. The illumination light source provides an illumination light through the illumination path to illuminate the regions of interest of the sample. Therefore, utilizing the guidance of the illumination path, photochemical reaction can be performed precisely within the region of interest while avoiding illumination outside the region of interest. As the previously mentioned, the distribution of the regions of interest affects sequences among several view fields, and the sequences affect the path. Thus, the paths among the multiple fields of view are various.

In the step 204, the processing module is configured to control the illumination light source and the pattern illumination device to illuminate the regions of interest based on the illumination sequence and the illumination path for each of the multiple fields of view.

In general, the purpose of the present invention provides a very efficient algorithm to reduce the illumination time but still can perform the Maximum area of photoreaction within the regions of interest. As described, the processing module controls the illumination assembly to illuminate each ROI positions. The illumination sequence provides the minimum distance between every two regions of interest so as to shorten the travel time of the illumination device. In addition, the illumination path can be conducted by traditional algorithm such as flooding algorithm. The illumination path of the present invention provides a method of reading as few pixels as possible and uses the least amount of memory allocations to accelerate the illumination progress. Certain exemplary embodiments according to the present disclosure are described as below.

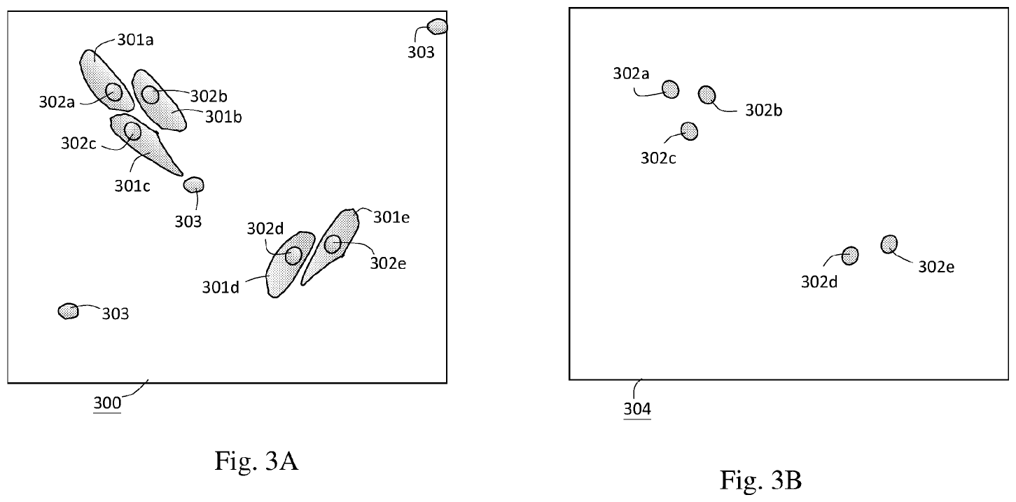

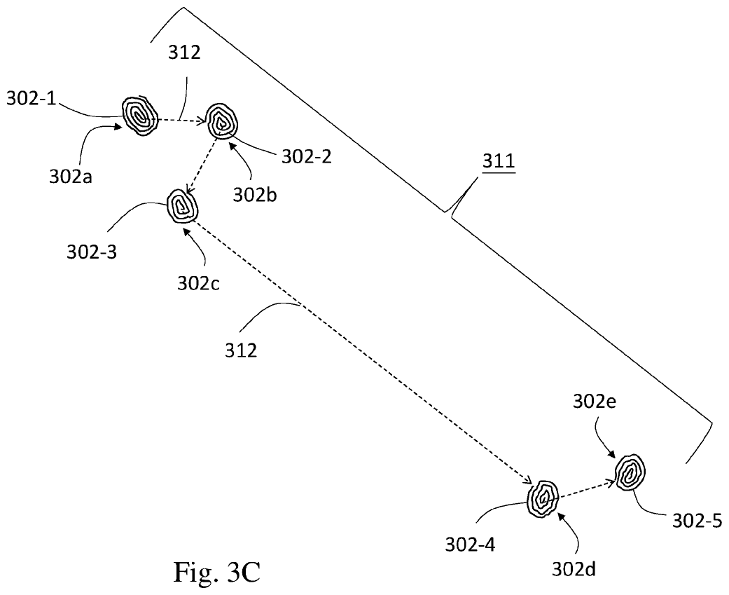

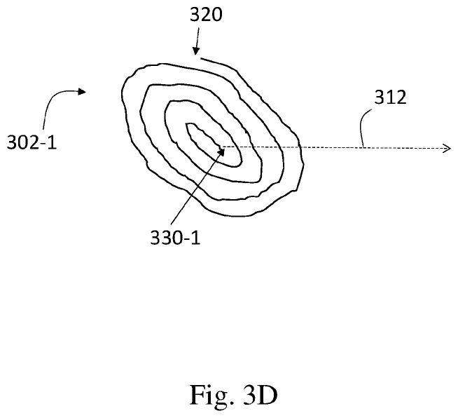

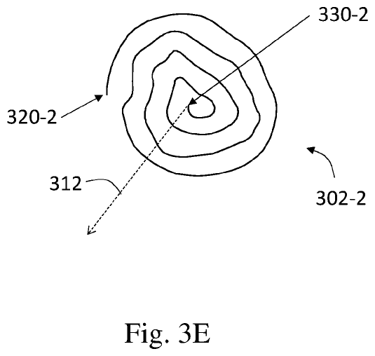

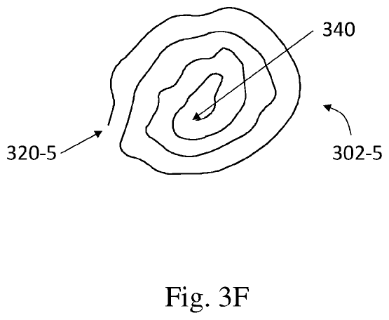

Please refer to FIGS. 3A to 3F. As shown in FIG. 3A, the field of view 300 of sample S contains cells 301a-301e, noncellular materials 303, and subcellular regions of interest 302a-302e, e.g., cell nuclei, can be identified by the processing module 14 by their morphology e.g., using an artificial intelligence model. In some embodiments, the artificial intelligence model incorporated in the processing module 14 is configured to provide or predict an illumination mask, which is used to control illumination of the cellular nuclei, namely the region of interest 302, for each cell 301. Due to the variable and diverse nature of biological samples, the size, shape, and location of the regions of interest to be illuminated, will differ in each field of view. The processing module 14 will therefore provide a different illumination mask for each field of view of the biological sample S.

An exemplary illumination mask 304 for field of view 300 is shown in FIG. 3B. The regions of interest 302a-302e correspond to the coordinates of the cell nuclei identified by the processing module 14 in field of view 300. Each of the regions of interest 302a-302e is separate from the other regions of interest; the regions of interest 302a-302e do not overlap or connect with each other in any of the illumination mask 304.

An exemplary illumination sequence 311 is shown in FIG. 3C. To begin the process of determining an illumination sequence, the processing module 14 raster scans the field of view 300 from an edge of the field of view 300. The processing module 14 is configured to calculate the distances between each region of interest 302a-302e and all of the other regions of interest 302a-302e in that field of view for global minimum distance strategy and to sort the regions of interest 302 in a scanning sequence, which is also the illumination sequence, based on the distribution of the regions of interest 302a-302e. For example, when the raster scanning path reaches the region of interest 302a, the region of interest 302a is the first area to scan and determined an illumination path 302-1. Then the first region of interest 302a could be used to be a foundation for sorting all of the regions of interest 302b-302e and defining the illumination sequence. As shown in FIG. 3C, the illumination sequence 311 is marked in dashed line 312 arranged in the order of 302a, 302b, 302c, 302d, and 302e. After determining the illumination sequence 311, the processing module scan the regions of interest of 302a, 302b, 302c, 302d, and 302e sequentially to determine the corresponding illumination path of 302-1, 302-2, 302-3, 302-4, and 302-5.

As described above, illumination light source 131 is a point light source such as a laser, and illumination of the regions of interest 302 is performed by moving the light source and/or the light along an illumination path. When a moving point of light is scanned across the regions of interest 302 during the illumination process, the overall illumination time for each field of view may depend, at least in part, on the order in which the regions of interest 302 are scanned. One aspect of the invention is a method and a system for identifying and implementing a scanning approach that minimizes time spent illuminating regions of interest in each field of view. In other word, the present invention provides a method to determine a minimum route to illuminate the entire regions of each of ROI by a filling algorithm e.g., flood filling method.

Please refer to FIGS. 3C and 3D, which are expanded views of illumination paths for regions of interest 302-1 and 302-2. After determining the illumination sequence 311, the progress module stars to calculate and determine the illumination path 302-1 of the first region of interest 302a. As shown in FIG. 3D, the raster scanning path arrived in the edge of the first region of interest 302a indicates the location of the start point 320, and the illumination path within a region of interest may be a spiral starting at the periphery of the region of interest and extending toward the center at an initial stop point 330-1. Therefore, according to the illumination path 320, the progressing module controls illuminating assembly to illuminate the first region of interest 302s from the start point 320, and temporally to cease the illumination at the initial stop point 330-1. The dashed line 312 represents the path of the illumination assembly moving to subsequent region of interest, e.g., 302b without illumination.

According to the illumination sequence 311, the progress module subsequently to calculate and determine the illumination path 302-2 of the second region of interest 302b. As shown in FIG. 3E, the raster scanning path arrived in the edge of the second region of interest 302b indicates the location of a resuming point 320-2, and the illumination path within a region of interest may be a spiral starting at the periphery of the region of interest and extending toward the center at a second stop point 330-2. Between the initial stop point 330-1 and resuming point 320-2 is a no-illumination portion, which is no-illumination by illumination light source 131 and pattern illumination device 132. Each of the stop points 330-n indicates an individual coordinate for switching to each of the resuming points 320-n+1. The illumination paths 302-3 and 302-4 are calculated and determined by the process module based on the same rule disclosed by the present invention.

FIG. 3F shows the illumination path 302-5 of the last region of interest 302e of the first field of view according to the determined illumination sequence 311. As shown in FIG. 3F, the raster scanning path arrived in the edge of the second region of interest 302e indicates the location of a resuming point 320-5, and the illumination path within a region of interest may be a spiral starting at the periphery of the region of interest and extending toward the center at a termination point 340. After reaching termination point 240, all regions of interest are fully illuminated, the processing module 14 controls the stage 15 to move to a subsequent field of view to begin the imaging, identifying region of interest, determining illumination sequence and illumination path, and conducting illuminating processes again.

As described above, the present invention therefore provides a novel algorithm to determine the distance between every two regions of interest 302 is minimized, and the total scanning distance through the regions of interest 302a, 302b, 302c, 302d, and 302e, in the sequence 302-1, 302-2, 302-3, 302-4, and 302-5 respectively, is minimized.

According to the present invention, each of the regions of interest is not overlapped or connected with any other region of interest in one of the fields of view. In some embodiments, if two or more regions of interest are very close to each other, the illumination path of these neighbor regions of interest may combine together to become a “joint illumination path”. To define whether two or more regions of interest are close enough to become “neighbors”, one skilled person in the art can use “4-neighbor graph model” or “8-neighbor graph model” to know which pixels are adjacent to a given pixel.

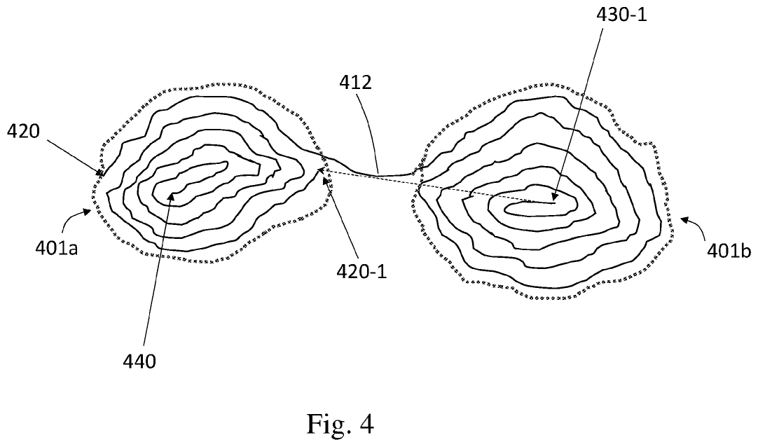

FIG. 4 depicts an exemplary of the joint illumination path. As shown in FIG. 4, the region of interest 401a and 401b is close to each other, and the dotted line represents the boundary of the region of interest thereof. In this embodiment, we assume that the region of interest 401a and 401b are the only two regions of interest in one field of view. When raster scanning path reaching the boundary of the region of interest 401a indicates the location of a start point 420, the illumination path 412 within a region of interest may be extend along with the boundary of the region of interest 401a and 401b, and then the illumination path 412 spirally extends to the center at an initial stop point 430-1. Next, the illumination path 412 jumps to a resuming point 420-1 within the boundary of the region of interest 401a and extends toward the center at a termination point 440.

The “joint illumination path” is a way to achieve the “local minima” of the illumination path for two neighbor regions of interest. It may illuminate a small area outside the regions of interest. If users do not want illuminate outside the regions of interest in any event, they can teach the processing module do not use the joint illumination path.

In still another embodiment, if the region of interest is an irregular shape instead of common round shape, the algorithm of joint illumination path can still be applied. It is similar with the exemplary in FIG. 4, multiple resuming points/stop points may exist in the illumination path within the regions of interest having irregular shape.

In certain embodiments, the illumination path of the present invention is calculated or determined by a filling algorithm e.g., flood filling method. The filling algorithm can be coded based on a self-defined numerical control code as shown in Table 1.

TABLE 1
Self-defined numerical control code

| Code | Response | code | Response |
|---|---|---|---|
| d10000 | turn up 1 step | d10005 | Turn left-down 1 step |
| d10001 | turn up-right 1 step | d10006 | Turn left 1 step |
| d10002 | turn right 1 step | d10007 | Turn left-up 1 step |
| d10003 | Turn right-down 1 step | d10008 | Jump to new coordinate |
| d10004 | Turn down 1 step | d10009 | termination |

In some embodiments, the self-defined numerical control code can be implemented on FPGA, MCU, CPLD, or PLC as encoder to translate the illumination path into two-dimension point coordinate. The point coordinate in the solid line determined by each code of d10000 to d10008 will be exposed under illumination energy one time. This method allows the system to save transferred data amount. Additionally, the self-defined numerical control code can be transferred as a one-dimensional array structure, which will occupy less memory, for a FIFO (first-in-first-out) implemented from a host computer to the processing module 14.

In the embodiment shown in Table 1, the control code order of the filling algorithm determines the illumination path to be drawn clockwise, as shown in FIG. 3D-3F. However, in the other embodiments, when order of the control code changes, the illumination path can be illustrated counterclockwise.

In some embodiments, since a total distance between every two interested regions 302 in the illumination sequence is minimized as shown in FIG. 3C, the number of the stop points and the resuming points is minimized to minimize the total distance between every two interested regions in the path.

After determining the illumination path, the processing module is further configured to control the illumination light source and the pattern illumination device to start illumination of the regions of interest at the start point or each resuming point, to temporally stop illumination of the regions of interest from each stop point to each resuming point, and to cease illumination of the regions of interest at the termination point for each of the multiple fields of view. Because the whole biological sample S can be divided into a plurality of fields of view, under different fields of view, the distribution of the regions of interest 302 would be different. The different distributions of the interested regions 302 affects the illumination sequence, and the sequences among different fields of view will therefore vary. Depending on the number of ROIs of illumination, the total time to photo-label proteins of a 2 cm×2 cm sample well using a 40× objective may range, e.g., from 2 to 15 hours.

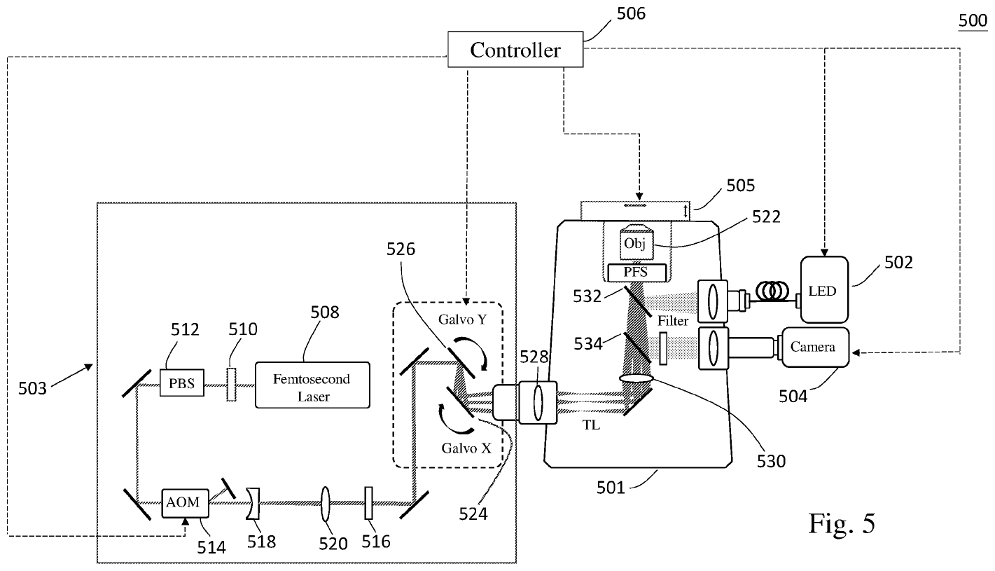

In one embodiment, a detailed microscope-based system for rapid illumination of a plurality of regions of interest among multiple fields of view of a biological sample according to the present invention is shown in FIG. 5. The microscope-based system 500 according to this disclosure includes a motorized inverted epifluorescence microscope 501 (e.g., a Nikon® Ti2-E microscope) with a drift-free focusing setup, a controller 506 (such as a desktop computer with a field programmable gate array), and an illumination subsystem 503. A software-firmware integrated program in controller 506 controls imaging, image segmentation, photochemical illumination, and field change in a tight coordination. Controller 506 controls an LED light source 502 for obtaining multicolor fluorescence images (e.g., 488 nm, 568 nm, 647 nm) from a sample on the microscope's stage 505 and a sCMOS camera 504 for capturing images of the sample. Widefield imaging of each color may take, e.g., 100 ms exposure time, with a color switch of 10 ms by LED's electronic shutter.

The images may be analyzed by controller 506 in real time to identify and segment regions of interest in the sample using either traditional image processing or deep learning embedded in the system. This step takes 0.1 to 1 sec depending on the processing complexity and image quality. In some embodiments, deep learning-based image segmentation may be used to identify regions of interest and to generate masks for complex images or poor-quality images. For example, hundreds of annotated images may be used to train a semantic segmentation model using a U-Net convolution neural network. Pre-processing and/or post/processing may also be implemented to improve training results, and the trained system may more efficiently perform image segmentation and mask generation. In some embodiments, the system uses a software-firmware integrated program to control and tightly coordinate image capture, image segmentation into regions of interest, photochemical illumination of the regions of interest, and stage movements to change field of view.

After image capture and processing by the system's controller 506, a mask is generated so that desired regions of interest in that field of view may be illuminated, e.g., with two-photo labelling of the regions of interest. The mask may be a collection of coordinates on the field of view of the sample corresponding to the regions of interest. The illumination subsystem uses a 780-nm femtosecond light source 508 (e.g., a Coherent® Chameleon Vision I laser) for two-photon illumination that triggers a photochemical reaction (chemical labeling) in x, y, and z directions. Two-photon illumination obtains better chemical labeling precision in the z direction.

Laser power is adjusted by rotating a half-wave plate 510, which can change the orientation of linear polarization of the laser, so the power can be attenuated by passing a polarizing beamsplitter cube 512. An acousto-optic modulator (AOM) 514 (such as a Gooch & Housego AOMO 3080-125 acousto-optic modulator) under the control of controller 506 acts as a femtosecond light shutter to switch the laser light on and off. A quarter wave plate 516 further changes the polarization of the laser beam to circular polarization. Lenses 518 and 520 expand the laser beam size to meet the requirements of the microscope objective 522.

Controller 506 controls a pair of galvanometer scanning mirrors (galvo mirrors) (Cambridge Technology® 6215H mirrors with 671 drivers) 524 and 526 to direct the femtosecond light through the microscope's scan lens 528 and tube lens 530 through the objective 522 to the sample on stage 505. To avoid any slowdown due to mechanical movement, multiband dichroic mirrors 532 and 534 (such as those described in the mirrors described in U.S. Application No. 63/354,806, filed Jun. 23, 2022, the disclosure of which is incorporated herein by reference) are used to allow multicolor imaging and femtosecond light illumination without movement of mechanical elements such as a turret or a shutter. After imaging, region of interest identification, mask creation, and two-photon illumination of the regions of interest in a field of view of the sample, the controller 506 moves the stage 505 so that imaging, region of interest identification, mask creation, and illumination can be performed on the next field of view. The process continues until all fields of view of the sample have been imaged. The only mechanical movements required in the process were the fast galvo scanning and the relatively slower stage movement toward the next field of view.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

1.-11. (canceled)

12. A computer implemented method for rapid illumination of a plurality of regions of interest among multiple fields of view of a biological sample executing in a processor of a computer, comprising:
for each field of view, identifying the plurality of the regions of interest to generate a two-dimensional illumination mask for each of the multiple fields of view;
for each field of view, determining an illumination sequence of the plurality of the regions of interest by minimizing a sum of the plurality of region-to-region traveling distances between sequential regions of interest;
for each field of view, determining an illumination path within each of the regions of interest; and
controlling an illumination light source and a pattern illumination device of a microscope-based system to illuminate the plurality of the regions of interest based on the illumination sequence and the illumination path for each of the multiple fields of view.

13. The computer implemented method of claim 12, wherein the region-to-region traveling distances is the sum of a straight-line distance between a center point of each of the plurality of the regions of interest.

14. The computer implemented method of claim 12, wherein the processor is further configured to control the illumination light source and the pattern illumination device to illuminate the plurality of the regions of interest according to the illumination path and to prevent illumination outside of each of the regions of interest.

15. The computer implemented method of claim 12, wherein the illumination path spirally extends to the center from a start point located at a boundary of a first region of interest of the sequence in each of the fields of view.

16. The computer implemented method of claim 12, wherein each of the regions of interest is not overlapped or connected with any other region of interest in one each of the fields of view.

17. The computer implemented method of claim 12, wherein the illumination path includes a plurality of stop points and resuming points, and each of the stop points indicates an individual coordinate for switching to each of the subsequent resuming points.

18. The computer implemented method of claim 17, wherein one of the resuming points is located within one of the regions of interest and surrounded by a boundary thereof, or located at the boundary of one of the regions of interest.

19. (canceled)

20. The computer implemented method of claim 17, wherein the step of determining the illumination path comprises minimizing a number of the stop points and resuming points so as to minimize a total distance between every two or more neighbor regions of interest in the illumination path, or within one region of interest.

21. The computer implemented method of claim 12, wherein the illumination path comprises a termination point for each field of view, and the method further comprises ceasing illumination of the illumination path for the each field of view at the termination point.

22. The computer implemented method of claim 21, wherein the processing module is further configured to control the illumination light source and the pattern illumination device to start illumination of the regions of interest at the start point or each resuming point, to temporally stop illumination of the regions of interest from each stop point to each resuming point, and to cease illumination of the regions of interest at the termination point for each of the multiple fields of view.

23.-33. (canceled)

34. The computer implemented method of claim 12, wherein utilizing the guidance of the illumination path, photochemical reaction can be performed within the plurality of regions of interest among multiple fields of view of the biological sample.
